(19) United States
(12) Patent Application Publication
(10) Pub. No.: US 2013/0208927 A1
(43) Pub. Date: Aug. 15, 2013

(54) AUDIO PLAYER AND METHOD USING SAME FOR ADJUSTING AUDIO PLAYING CHANNELS

(71) Applicant: YIN-ZHAN WANG, Shenzhen City (CN)

(72) Inventor: YIN-ZHAN WANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/528,845

(22) Filed: Jun. 21, 2012

(30) Foreign Application Priority Data
Feb. 15, 2012 (CN) 201210033921.9

(51) Int. Cl. H04R 5/02

(52) U.S. Cl. 381/306

(57) ABSTRACT

A media player includes a sound output driver, and a display unit. The sound output driver plays a channel test file for the output of only left and only right audio driving signals. The display unit displays icons indicating the audio channel being driven. A user observes the positions of channel playing icons and hears sounds from one earphone or the other, and determines whether the positions of the left and right earphones as worn are correct or reversed. The sound output driver can exchange or swap the left and right audio driving signals when the earphones are worn in a reversed fashion.

### BACKGROUND

1. Technical Field

The present disclosure relates to audio players and a method using the same for adjusting audio playing channels.

2. Description of Related Art

A media player, such as one able to process a moving picture experts group audio layer III (MP3) or a smart phone, may play music using a pair of earphones, namely left earphone and right earphone, and output left channel sound via the left earphone and right channel sound via the right earphone. However, since the left and right earphones normally have very similar configuration, it is not easy for a user to distinguish them and the user may insert the left earphone into the right ear and the right earphone into the left ear, and the wrongly employed earphones may decrease the user experience and the perceived playback quality.

Therefore, an audio player and a related method having function to overcome the above-described shortcomings are needed.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of an audio player according to one embodiment of the present disclosure, the audio player including a display unit and employing a pair of earphones.

FIG. 2 is a schematic diagram of pair of earphones of FIG. 1, according to one embodiment of the present disclosure.

FIGS. 3-4 are schematic diagrams of different states of a channel control interface on the display unit of FIG. 1, according to one embodiment of the present disclosure.

FIG. 5 is a flowchart of an audio playing method using the audio player of FIG. 1, according to one method embodiment of the present disclosure.

### DETAILED DESCRIPTION

Reference will be made to the drawings to describe various embodiments.

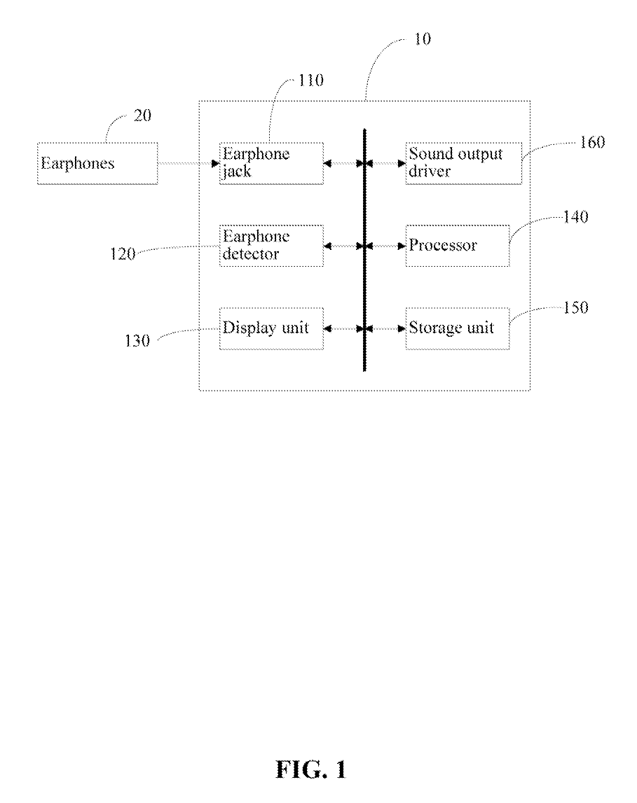

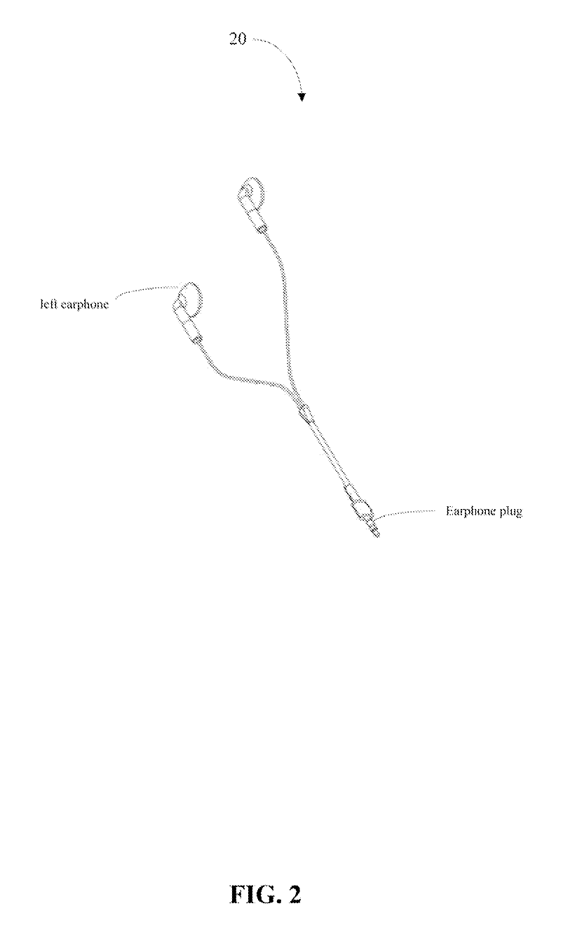

FIG. 1 is a block diagram of an audio player 10 according to one embodiment of the present disclosure. The audio player 10 employs a pair of earphones 20 as shown in FIG. 2, namely left earphone and right earphone. The audio player 10 includes an earphone jack 110, an earphone detector 120, a display unit 130, a processor 140, a storage unit 150, and a sound output driver 160. The audio player 10 can playback any type of media files.

The earphone jack 110 connects to an earphone plug of the pair of earphones 20.

The earphone detector 120 is configured to determine whether the earphone plug of the pair of earphones is inserted into the earphone jack 110. The earphone detector 120 generates a channel control signal and sends the channel control signal to the processor 140 when the earphone plug of the pair of earphones is inserted into the earphone jack 110. In alternative embodiments, the audio player 10 may include a physical key (not shown) to generate the channel control signal, when the physical key is pressed by a user.

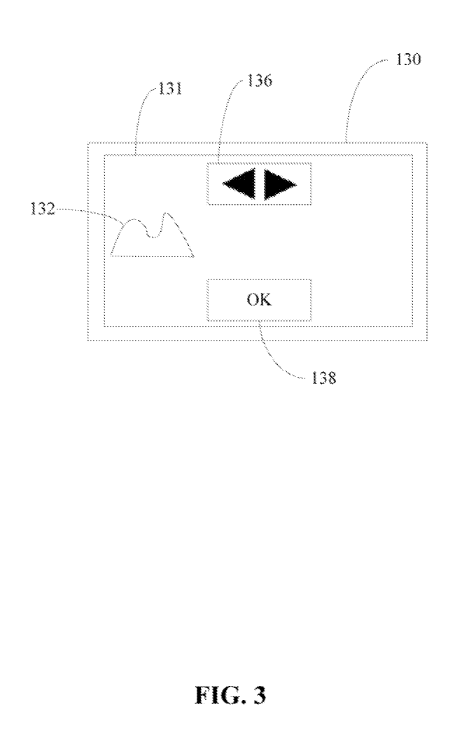

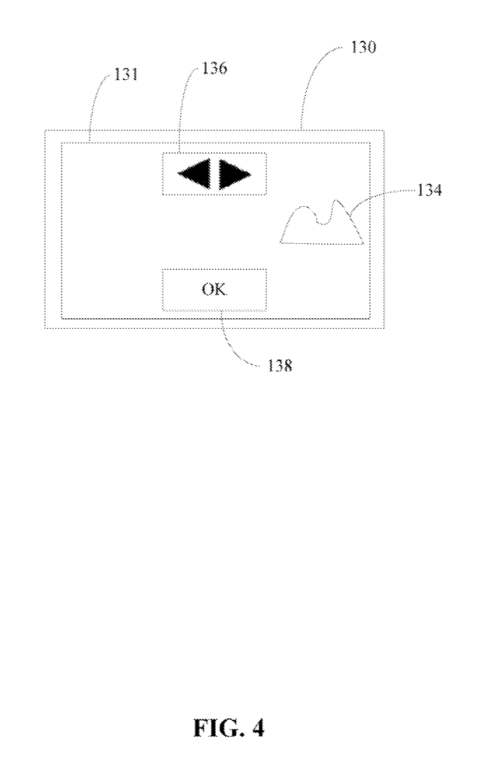

The display unit 130 displays a channel control interface 131 as shown in FIGS. 3-4. The channel control interface 131 includes a left channel playing icon 132 as shown in FIG. 3, a right channel playing icon 134 as shown in FIG. 4, a channel exchange button 136, and an OK button 138. In one embodiment, the display unit 130 is a touch display, and the user can input commands by pressing or touching the displayed icons of the channel control interface 131. In the embodiment, the processor 140 generates a driving control signal when the channel exchange button 136 is pressed or touched, and provides the driving control signal to the sound output driver 160 for toggling an operation mode of the sound output driver 160.

In alternative embodiments, the audio player 10 may further include an input unit such as a keypad for the user to input commands corresponding to the buttons of the channel control interface 131.

The storage unit 150 pre-stores one or more media files. In the embodiment, the storage unit 150 further stores a channel test file. In one embodiment, the storage unit 150 can be selected from a group consisting of compact discs (CDs), digital video discs (DVDs), BLU-RAY disks, flash memory, and hard disk drives.

The sound output driver 160 generates a left channel driving signal and a right channel driving signal according to the media file or the channel test file. In a first driving mode, the sound output driver 160 outputs the left and right audio driving signals to the left and right earphones respectively. In a second driving mode, the sound output driver 160 outputs the right and left audio driving signals to the left and right earphones respectively. In alternative embodiments, the sound output driver 160 further includes a switch (not shown) for receiving the driving control signal from the processor 140 to change the operation of the sound output driver 160 from the first driving mode to the second driving mode, or vice versa. In alternative embodiments, a program in the form of one or more computerized instructions stored in the storage unit 150 and executed by the processor 140 may be performed to change the mode of operation of the sound output driver 160.

In operation, when the channel control signal is generated by the earphone detector 120 or the physical key and sent to the processor 140, the processor 140 controls the display unit 130 to display the channel control interface 131 thereon. The processor 140 also controls the sound output driver 160 to generate a left channel driving signal and a right channel driving signal to drive the pair of earphones 20 according to the channel test file.

When the sound output driver 160 operates in the first driving mode for example, the left channel playing icon 132 is displayed on left side of the display unit 130 and the right channel playing icon 134 is not visible on the display unit 130 as shown in FIG. 3 while the sound output driver 160 only outputs the left audio driving signal to the left earphone. When the sound output driver 160 is outputting only the right audio driving signal to the right earphone, the left channel playing icon 132 is hidden from the display unit 130 and the right channel playing icon 134 is displayed on right side of the display unit 130 as shown in FIG. 4.

When the sound output driver 160 is started up and is in the second driving mode, the left channel playing icon 132 is displayed on the left side of the display unit 130 and the right channel playing icon 134 is not visible on the display unit 130, as shown in FIG. 3, while the sound output driver 160 only outputs the left audio driving signal to the right earphone. The left channel playing icon 132 is hidden from the display unit 130 and the right channel playing icon 134 is displayed on the right side of display unit 130, as shown in FIG. 4, while the sound output driver 160 only outputs the right audio driving signal to the left earphone.

While wearing the left and right earphones, the user can determine simply whether positions of the left and right earphones comply with positions of the left and right channel playing icons 132, 134, by observing the positions of the alternatively displayed channel playing icons 132, 134 and hearing a sound, or not hearing a sound as the case may be, from the left earphone and from the right earphone. In other words, if only the left ear of the user hears sound when the left channel playing icon 132 is displayed and only the right ear of the user hears sound when the right channel playing icon 134 is displayed, the user can be satisfied that the positions of the left and right earphones are standard or regular, as complying with the positions of the left and right channel playing icons. In this situation, the user directly presses or touches the OK button 138 to exit the channel control interface 131 to enter a normal playback mode and display the normal audio playing interface (not shown).

Conversely, if only the right ear of the user hears sound when the left channel playing icon 132 is displayed and only the left ear of the user hears sound when the right channel playing icon 134 is displayed, the user knows that the positions of the left and right earphones are reversed, and do not comply with positions of the left and right channel playing icons. In this situation, the user can press or touch the channel exchange button 136 to change the operation of the sound output driver 160 from the first driving mode into the second driving mode, that is, exchange the left and right audio driving signals being output to the left and right earphones. The user then presses or touches the OK button 138 to exit the channel control interface 131 to enter a normal playback mode.

The audio player 10 enables the user to determine whether the left and right earphones are in the wrong ears and, even if the earphones are in the wrong ears, to compensate by enabling the reverse operation of the left and right audio driving signals.

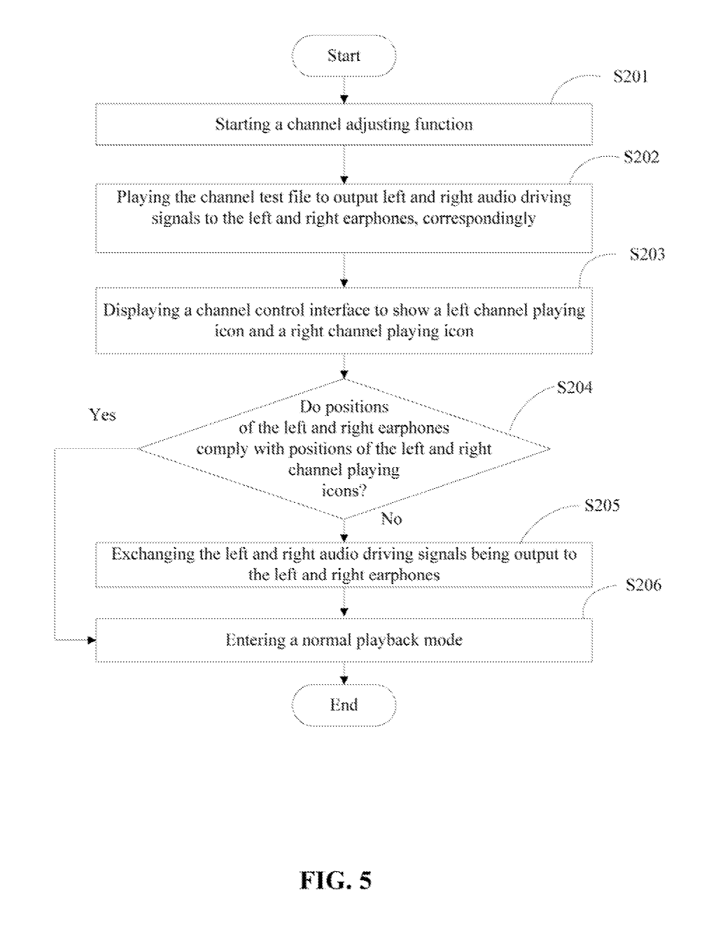

FIG. 5 is a flowchart of an audio playing method according to one embodiment of the present disclosure. The method is carried out using the audio player 10. Depending on the embodiment, additional steps may be added, others removed, and the ordering of the steps may be changed.

In step S201, the earphone detector 120 generates a channel control signal and sends the channel control signal to the processor 140 when the earphone plug of the pair of earphones 20 is inserted into the earphone jack 110. The processor 140 starts a channel adjusting function when the processor 140 receives the channel control signal. In alternative embodiments, the channel control signal may also be generated by the user pressing a physical key of the audio player 10.

In step S202, the processor 140 controls the sound output driver 160 to generate a left channel driving signal and a right channel driving signal according to the channel test file for playing the channel test file. In a first driving mode, the sound output driver 160 outputs the left and right audio driving signals to the left and right earphones respectively. In a second driving mode, the sound output driver 160 outputs the right and left audio driving signals to the left and right earphones respectively.

In step S203, the processor 140 controls the display unit 130 to display the channel control interface 131 as shown in FIGS. 3-4. The channel control interface 131 includes a left channel playing icon 132 as shown in FIG. 3, a right channel playing icon 134 as shown in FIG. 4, a channel exchange button 136, and an OK button 138. When the sound output driver 160 is in the first driving mode, only the left channel playing icon 132 is displayed on the display unit 130 and the right channel playing icon 134 is not visible on the display unit 130 while the sound output driver 160 only outputs a left audio driving signal to the left earphone. The left channel playing icon 132 is not visible on the display unit 130 and only the right channel playing icon 134 is displayed on the display unit 130 while the sound output driver 160 only outputs a right audio driving signal to the right earphone. When the sound output driver 160 is in the second driving mode, only the left channel playing icon 132 is displayed on the display unit 130 and the right channel playing icon 134 is not visible on the display unit 130 while the sound output driver 160 only outputs a left audio driving signal to the right earphone. The left channel playing icon 132 is not visible on the display unit 130 and only the right channel playing icon 134 is displayed on the display unit 130 while the sound output driver 160 only outputs a right audio driving signal to the left earphone.

In alternative embodiments, the left and right channel playing icons 132, 134 may flicker on the display unit 130 instead of being constantly displayed or not being displayed on the display unit 130, to show their positions.

In step S204, the user can determine whether the positions of the left and right earphones comply with positions of the left and right channel by observing the playing icon 132 or (as the case may be) the playing icon 134 and hearing sound from only the left earphone or (as the case may be) only the right earphone. If the positions of the left and right earphones as worn by the user are in compliance with the displayed positions of the left and right channel playing icons, the process goes to step S206. If the positions of the left and right earphones as worn by the user are not in compliance with the displayed positions of the left and right channel playing icons, the process goes to step S205.

In step S205, when the user presses or touches the channel exchange button 136, the processor 140 generates a driving control signal to the sound output driver 160 to toggle the operation of the sound output driver 160 from the first driving mode into the second driving mode, to exchange audio channels.

In step S206, when the user presses or touches the OK button 138, the processor 140 controls the channel control interface 131 to exit and allow a normal playback mode (playing interface is not shown).

It is to be understood that even though numerous characteristics and advantages of the present embodiments have been set forth in the foregoing description, with details of the structures and functions of the embodiments, the disclosure is illustrative only; and changes may be in detail, especially in the matters of arrangement of parts within the principles of the embodiments to the full extent indicated by the broad general meaning of the terms in which the appended claims are expressed.

What is claimed is:

1. A audio player comprising:
a storage unit storing a channel test file;
a sound output driver playing the channel test file to output left and right audio driving signals to left and right earphones, correspondingly; and
a display unit displaying a channel control interface to alternatively show a left channel playing icon on the left side of the display unit and a right channel playing icon on the right side of the display unit corresponding to the left and right audio driving signals,
wherein a user observes positions of the alternatively displayed channel playing icons and hears sound correspondingly from left and right earphones to determine whether the positions of the left and right earphones comply with the positions of the left and right channel playing icons, the sound output driver exchanges the left and right audio driving signals output to the left and right earphones when the positions of the left and right earphones do not comply with the positions of the left and right channel playing icons.

2. The audio player of claim 1, further comprising an earphone jack configured to connect to an earphone plug of the earphones.

3. The audio player of claim 2, further comprising an earphone detector configured to determine whether the earphone plug of the earphones is inserted into or connected to the earphone jack.

4. The audio player of claim 3, wherein when the earphone plug of the earphones is inserted into or connected to the earphone jack, the earphone detector generates a channel control signal and sends the channel control signal to the processor, the processor controls the display unit to display the channel control interface for starting a channel adjusting function of the audio player.

5. The audio player of claim 4, wherein the channel control interface further comprises a channel exchange button, and an OK button.

6. The audio player of claim 5, wherein the display unit is a touch display, and a user can input commands by touching the icons of the channel control interface displayed on the touch display.

7. The audio player of claim 6, wherein the user touches the channel exchange button to control a processor to generate a driving control signal, the processor provides the driving control signal to the sound output driver for exchanging the left and right audio driving signals.

8. The audio player of claim 1, wherein the storage unit pre-stores the channel test file.

9. The audio player of claim 1, wherein the storage unit is selected from a group consisting of compact discs (CDs), digital video discs (DVDs), BLU-RAY disks, flash memory, and hard disk drives.

10. The audio player of claim 1, wherein the sound output driver operates in a first driving mode and a second driving mode, in a first driving mode, the sound output driver outputs the left and right audio driving signals to the left and right earphones, respectively, in a second driving mode, the sound output driver outputs the right and left audio driving signals to the left and right earphones, respectively.

11. The audio player of claim 10, wherein the left channel playing icon is displayed on the display unit and the right channel playing icon is not visible on the display unit while the sound output driver outputs only the left audio driving signal to the left earphone, the left channel playing icon is hidden from the display unit and the right channel playing icon is displayed on the display unit while the sound output driver outputs only the right audio driving signal to the right earphone.

12. A audio playing method comprising:
outputting left and right audio driving signals by a sound output driver to left and right earphones, correspondingly;
displaying a channel control interface on a display unit to alternatively show a left channel playing icon on the left side of the display unit and a right channel playing icon on the right side of the display unit corresponding to the left and right audio driving signals;
observing positions of the alternatively displayed channel playing icons, and hearing the correspondingly sound from left and right earphones;
determining whether the positions of the left and right earphones comply with positions of the left and right channel playing icons; and
exchanging the left and right audio driving signals output to the left and right earphones by the sound output driver when the positions of the left and right earphones do not comply with positions of the left and right channel playing icons.

13. The audio playing method of claim 12, further comprising a process of determining whether an earphone plug of the earphones is inserted into or connected to an earphone jack.

14. The audio playing method of claim 13, further comprising a process of generating a channel control signal and sending the channel control signal to a processor when the earphone plug of the earphones is inserted into or connected to the earphone jack.

15. The audio playing method of claim 14, wherein the processor controls the display unit to display the channel control interface for starting a channel adjusting function when the processor receives the channel control signal.

16. The audio playing method of claim 12, wherein the channel control interface further comprises a channel exchange button, and an OK button.

17. The audio playing method of claim 16, wherein the display unit is a touch display, and commands is inputted by touching the buttons of the channel control interface displayed on the touch display.

18. The audio playing method of claim 17, wherein the channel exchange button is touched to control a processor to generate a driving control signal, the processor provides the driving control signal to the sound output driver for exchanging the left and right audio driving signals.

19. The audio playing method of claim 12, further comprising a process of pre-storing a channel test file, the left and right audio driving signals are generated according to the pre-stored channel test file.

20. The audio playing method of claim 12, wherein the sound output driver operates in a first driving mode and a second driving mode, in a first driving mode, the sound output driver outputs the left and right audio driving signals to the left and right earphones, respectively, in the second driving mode, the sound output driver outputs the right and left audio driving signals to the left and right earphones, respectively, the left channel playing icon is displayed on the display unit and the right channel playing icon is not visible on the display unit while the sound output driver outputs only the left audio driving signal to the left earphone, the left channel playing icon is hidden from the display unit and the right channel playing icon is displayed on the display unit while the sound output driver outputs only the right audio driving signal to the right earphone.
